(19) United States
(12) Patent Application Publication
(10) Pub. No.: US 2006/0004555 A1
(43) Pub. Date: Jan. 5, 2006

(54) Well-managed virtual hospital

(76) Inventor: Anthony Kelly Jones, Alpharetta, GA (US)

Correspondence Address: Anthony K. Jones, P. O. Box 3330, Alpharetta, GA, 30023, US

(21) Appl. No.: 11/072,917

(22) Filed: Jun. 1, 2005

Related U.S. Application Data
(60) Provisional application No. 60/550,798, filed on Mar. 5, 2004.

(51) Int. Cl. G06G 7/48; G09B 19/00; G09B 23/28; G09B 5/00

(52) U.S. Cl. 703/6; 434/219; 434/262; 434/308

(57) ABSTRACT

The Well-Managed Virtual Hospital is a web-based and compact disc-based, 3-D interactive audiovisual business simulation of managing a real hospital. The primary purpose of the simulation is to serve as a training, education and entertainment tool. The primary target audience for the tool is the hospital board of directors, senior and middle management, medical staff leadership, and conference attendees. The business simulation uses graphic user interface (GUI) capabilities in concert with a decision-making database management system. When combined, the GUI and database management system convey to the user the appearance and experience of making decisions in a real hospital. The computer-based simulation has the capacity to accommodate up to five participants functioning as a single “virtual” management team. The simulation is structured so an organization can have up to 10 teams going through the simulation at the same time. A balanced scorecard is present throughout the simulation to give the team real-time feedback on the effectiveness and impact of the decisions they are making as a management team.

### CROSS REFERENCE TO RELATED APPLICATIONS

The present application is a continuation of application Ser. No. 60/550,798 (provisional) and update of Ser. No. 11/072,917 filed Mar. 4, 2005.

Application Ser. No. 60/550,798 (provisional) and update of Ser. No. 11/072,917 filed Mar. 4, 2005.

### SUMMARY OF INVENTION

The Well-Managed Virtual Hospital, also referred to as the vHospital, is a computer-based software program simulating running a real hospital. The purpose of the web-based, compact disc-based simulation is to serve as a management training and development tool for hospital and healthcare executives. Participants will experience a very realistic hospital business simulation that is coupled with humor, education and entertainment along the way.

Using artificial intelligence, the business simulation introduces participants to the many complexities and challenges of operating a large metropolitan hospital. The computer-based simulation has the capacity to accommodate up to five (5) participants functioning as a single “virtual” management team. As the virtual management team performs a routine weekly tour of the hospital, it will be required to make key decisions about the strategic, operational and financial aspects of how the hospital and medical center are operated. The team's tour will include visiting many areas of the hospital including the Emergency Department, Operating Room, Radiology, ICU and medical/surgical nursing units.

The Virtual Hospital simulation is structured so an organization can have up to ten (10) teams [a maximum of five members on each virtual management team] going through the simulation at the same time. There are a number of upfront parameters the teams will have to contend with and use as guides in their decision-making processes, as they progress through the simulation. However, the outcomes will invariably be different do to the menu of “numerous” choices and challenges that will be facing each team.

Individuals and teams participating in the Virtual Hospital will not only be able to review the results of their decision-making processes, but they will also be able to readily see the impact of those decisions on various departments, and more importantly, the hospital as a whole. A unique aspect of the Virtual Hospital is each team's results from the simulation can be compared to other teams that simultaneously went through the simulation with it, but some how, had a different outcome. This comparison in itself can prove to be interesting.

The ultimate goal and value of the Well-Managed Virtual Hospital is it creates a:
Greater understanding of the complexities of the decision-making process that occurs in the hospital setting
Higher level of trust within the management team due the increased level of understanding
Improved communication vertically, horizontally and diagonally
More cohesive management team moving in the same direction
An accelerated management decision-making processes
Increased management effectiveness due to more members of the team getting on the same page
Measurably improved performance indicators, including: strategic direction, operational efficiency, employee morale and operating margin

The Virtual Hospital is a computerized and transportable tool that can be used in many different settings and formats including management retreats and training sessions.

The purpose of the virtual hospital simulation is to:
To train, educate & entertain
Experience a realistic business simulation
Promote better understanding roles & organizational functions
Improve communications & trust across the org.
Develop more effective & accelerated decision-making process
Improve individual, group & organizational performance

The target audience of the simulation is:
Board of Directors
Senior Executives
Middle Management
Medical Staff
First Line Supervisors
Conferences & Retreats
Strategic Plan Preparations

The challenges encountered in the simulation include:
Strategic
Operational
Financial
Political
Regulatory
Quality
Relationships

The features of the simulation include:
Game setting/world: 3-D big city, urban hospital
Story-line: financially & operationally struggling hospital (or can there be more than one scenario or situations?)
Basic background information on the hospital will provided at the beginning of the game
Type of game: real-time strategy
Team-based game
Progressions through the game can be: 1) linear with a specific start & stop point, or 2) multiple starting points & random movement
Game requires progressing through several modules (basic, moderate & difficult) of decision-making to achieve ultimate success
Each time the team makes a decision, it can enter the “Decision Room” where the use of cumulative data & information is allowed
Time-limit placed on “each” decision made; time limit placed on the entire game
Learning objectives stated up-front
Type of challenge: intelligence-based &/or knowledge-based (factual & intuitive)
Unexpected “pop-ups” problems (challenges) will randomly occur along the way in all of the above areas
Victory conditions: team that scores the highest number of points wins

There are three primary goals of the virtual hospital simulation:
To Transfer Knowledge
To Sharpen Management Skills
To Improve Performance

One of the keys to significant knowledge transfer and performance improvement is “LEARNING”.

From a learning perspective, studies have shown that we retain:
10% to 20% (of what we SEE)
10% to 20% (of what we HEAR)
50% to 60% (of what we SEE & Hear)
Up to 80% (of what we “Interact With”)

Clearly, training and development through “interaction” carries a significant advantage in the learning process, and the use of technology such as the Virtual Hospital is a major enabler in the learning process.

### BRIEF DESCRIPTION OF DRAWINGS (FIGURES)

FIG. 1: Display of Emergency Department Waiting Room with Automated Balanced Scorecard and Graphic User Interface Icons. (Hospital executives will enter the hospital through a department such as this Emergency Room)

FIG. 2: Display of Emergency Department Treatment Area with Automated Balanced Scorecard and Graphic User Interface Icons. (Hospital executives are touring the Emergency Room Treatment Area)

FIG. 3: Computer Graphic Display of “Decision Room Instructions” with Automated Balanced Scorecard and Graphic User Interface Icons. (When first entering the Decision Room, hospital executives will receive their instructions from the computer screen on how to use and navigate the Decision Room)

FIG. 4: Graphic Display of “Overview of Management Decision-Making Database with Automated Balanced Scorecard and Graphic User Interface Icons.” (The management decision database will contain at least 392 possible decisions for the participants to choose from)

FIG. 5: Graphic Display of “Decision Room with Automated Balanced Scorecard and Graphic User Interface Icons”

FIG. 6: Graphic Display of “Hospital Reports and Data on Computer Screen with Automated Balanced Scorecard and Graphic User Interface Icons.” (Hospital reports, to be used during the decision-making process, will be positioned throughout the Decision Room including on the computer screen)

FIG. 7: Graphic Display of “Emergency Department Performance Scorecard” with Automated Balanced Scorecard and Graphic User Interface Icons.” (The scorecard is to be reviewed and used by the executive team)

FIG. 8: Graphic Display of “Operating Room Performance Scorecard with Automated Balanced Scorecard and Graphic User Interface Icons.” (The scorecard is to be reviewed and used by the executive team)

FIG. 9: Graphic Display of “Hospital Nursing Unit with Automated Balanced Scorecard and Graphic User Interface Icons.” (The scorecard is to be reviewed and used by the executive team)

FIG. 10: “Performance Indicators” in Bar Chart Format (Hospital-Wide). (FIG. 10 is example of the decision selected made by the executive team and the points accrued from those decisions)

FIG. 11: “Performance Indicators” in Bar Chart Format (Emergency Department). (FIG. 11 is example of the decision selected made by the executive team and the points accrued from those decisions)

FIG. 12: Computer Graphic Display of “Pending Decisions in Decision Room with Automated Balanced Scorecard and Graphic User Interface Icons.” FIG. 12 is an example of the types of decisions that will confront the executive team during their decision-making process)

FIG. 13: Graphic Display of “Multiple Team Results in Decision-Making” Simulation (Bar Chart). (FIG. 13 gives an overview of decision results for ten teams, and includes the Scoring Guideline to demonstrate how successful they were based on scores)

FIG. 14: Graphic Display of “Multiple Team Results in Decision-Making” Simulation (Bar Chart with Stacked Performance Indicators). (FIG. 13 gives an overview of decision results for ten teams, and with a stratification by performance indicator)

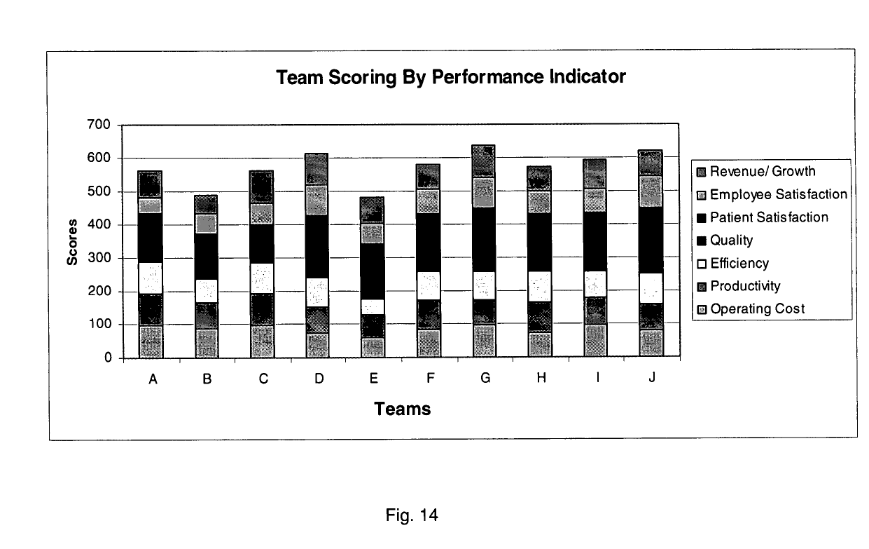

FIG. 15: Graphic Display of “Single Team Results by Performance Indicator.” (in Bar Chart Format) (FIG. 15 displays the decision results of one team [Team A])

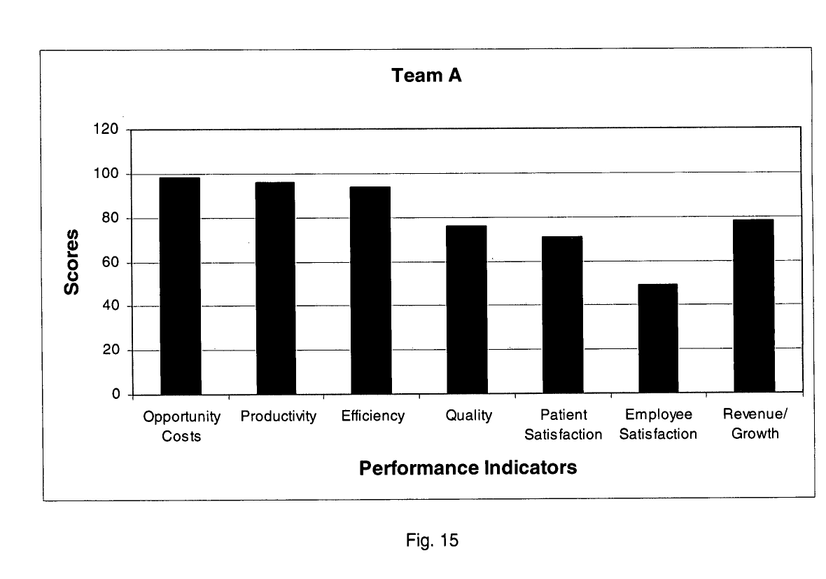

FIG. 16: Graphic Display of “Multiple Team Scores by Various Hospital Departments Toured” (in Tabular Format). (FIG. 16 provides a scoring break-down of how each one of the ten teams did in each department they toured)

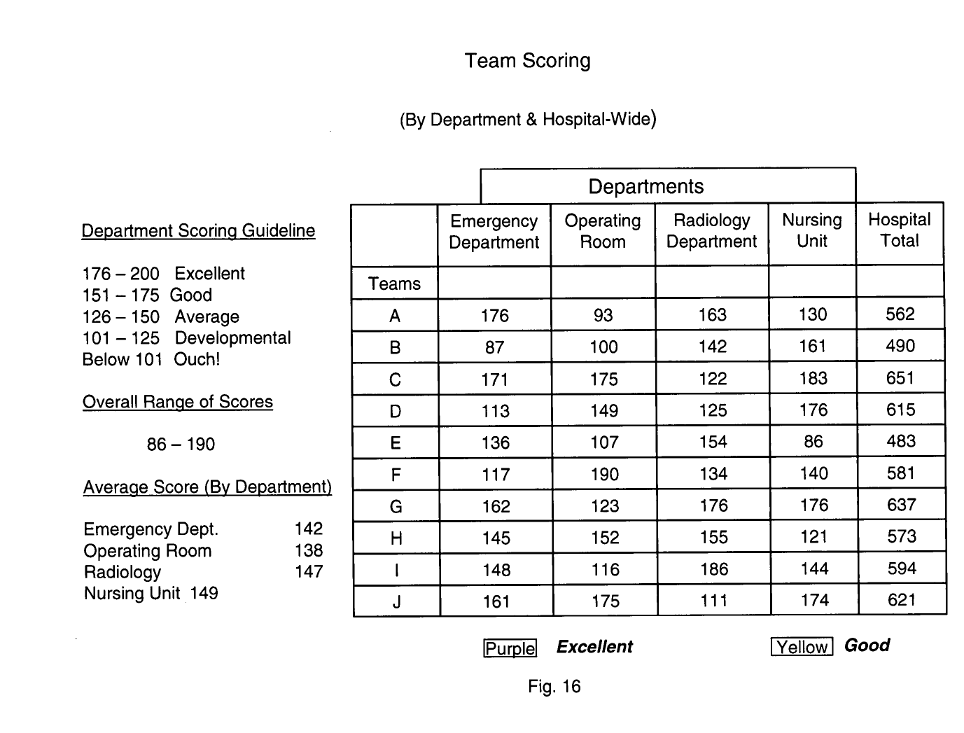

FIG. 17: “Total Team Scores Stratified by Each Performance Indicator “(in Tabular Format). (FIG. 17 converts all ten teams' scores [section #1] into quantifiable results [section #2] to show how well they were able to close the targeted performance gaps)

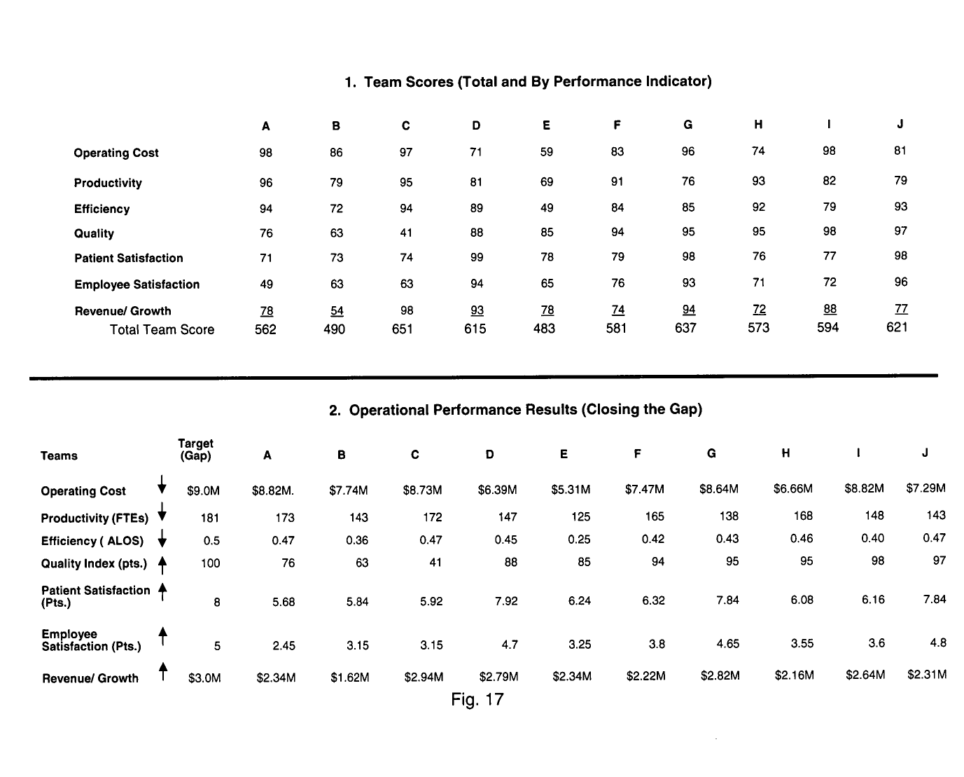

FIG. 18: Graphic Display of “Operational Performance Results by Team.” (FIG. 18 is the same data from section #2 in FIG. 17, how well the teams did in closing the performance gaps)

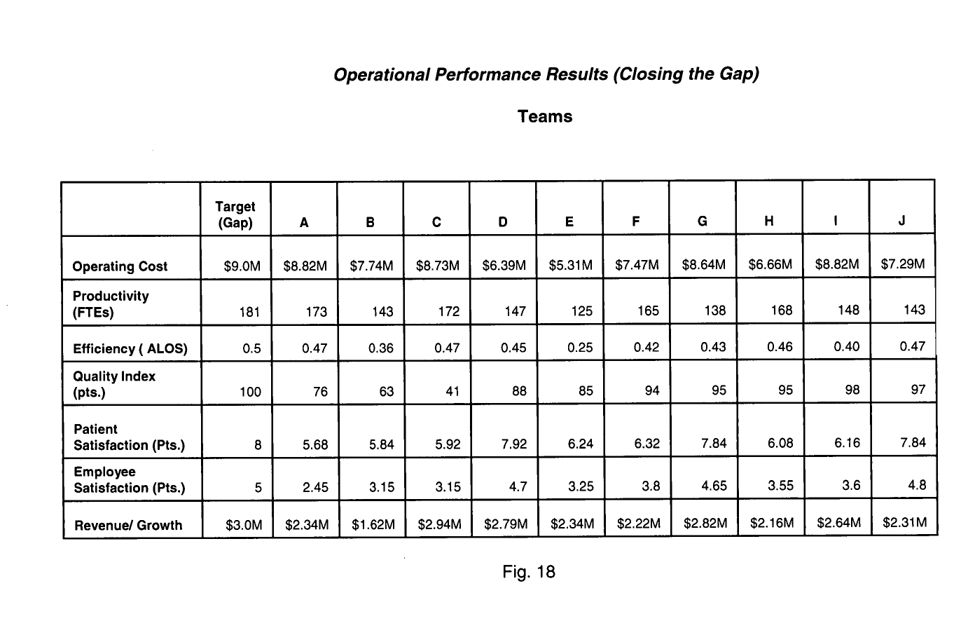

FIG. 19: Graphic Display of “Overall Scorecard Containing All Teams' Summary Scores.” (FIG. 19 converts each teams raw score into a percentage ranking to gauge how successful they were in making decisions)

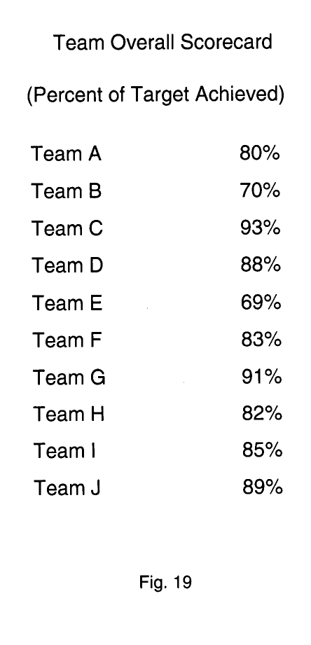

FIG. 20: Graphic Display “Comparing Highest and Lowest Scoring Teams”

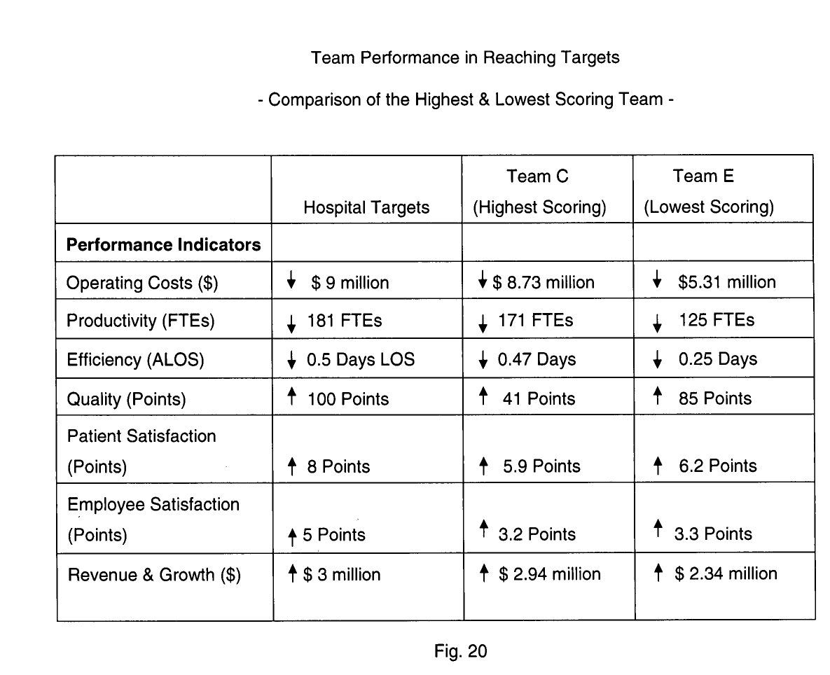

### COMPELLING FEATURES OF THE VIRTUAL HOSPITAL SIMULATION

The most compelling feature of The Virtual Hospital is its ability to complement & integrate into any hospital management and leadership training and development program, including:
Board Orientation & Development
Management Training & Development
Medical Staff Leadership Development

### SIGNIFICANT BENEFITS OF THE HOSPITAL SIMULATION to PARTICIPANTS

Some of the significant benefits of using this simulation for training purposes are to:
Develop an appreciation for the complexities of operating a hospital
Develop a higher level of trust within the management team
Improve communication throughout the organization
Develop a more cohesive management team
Integrate and accelerate the decision-making process
Increase management effectiveness
Improve performance
Stimulate the thought process!!
Accelerate the learning process!!
Fun and entertaining!!

The essence of the performance improvement process lies in strengthening individuals' core competencies in the management areas. The virtual hospital simulation seeks to improve individual and team skills in baseline management and core competency requirements including:
Performance Improvement
Systems Thinking
Team Building
Collaboration and Communication
Change Management
Budget and Financial Management
Staffing & Scheduling
Productivity & Efficiency Management
Customer Service
Effective Decision-Making

### DETAILED DESCRIPTION OF THE INVENTION

The computer-based software simulation can be customized to individual hospitals. It has the capacity to accommodate up to five (5) participants functioning as a single “Virtual Management Team.” During the tour in the E. D. prototype, the five team members will consist of the CEO, CFO, CNO, E. D. Nursing Director and E. D. Medical Director. As the Virtual Management Team performs a routine weekly tour of the hospital, the Virtual Management Team will be confronted with the strategic, operational and financial issues and problems related to improving the performance of the medical center. Using a balanced scorecard system, the actual decision-making process for the team will occur at the end of the tour in the “Decision Room” where they will have access to information to assist them during their deliberations.

The Virtual Management Team's performance will be measured based on a point system. The Team's points will accumulate as they progress through the hospital tour that includes the Emergency Department, Operating Room, Radiology, and nursing units. These four areas (modules) will constitute the focal point of the tour. The results of each team's effectiveness in the decision-making process will be judged by how well they generate points to achieve the stated performance targets under the following structure:
Total number of overall points (score) generated, and
How well each team balanced the needs of each department against the needs of the overall hospital. (This will be reflected in the departmental scores.)

### HOW THE VIRTUAL HOSPITAL SIMULATION IS CONSTRUCTED

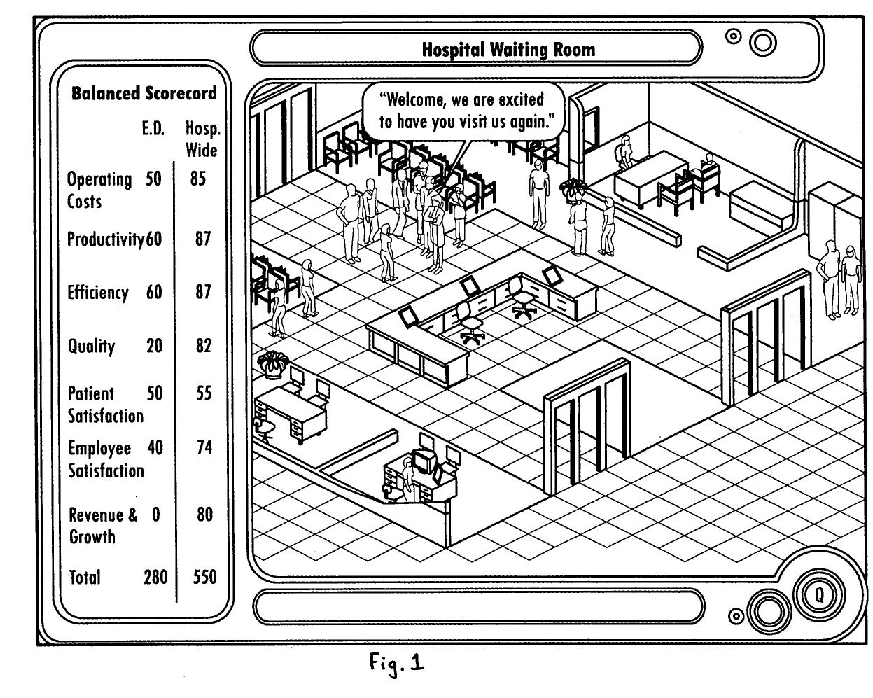

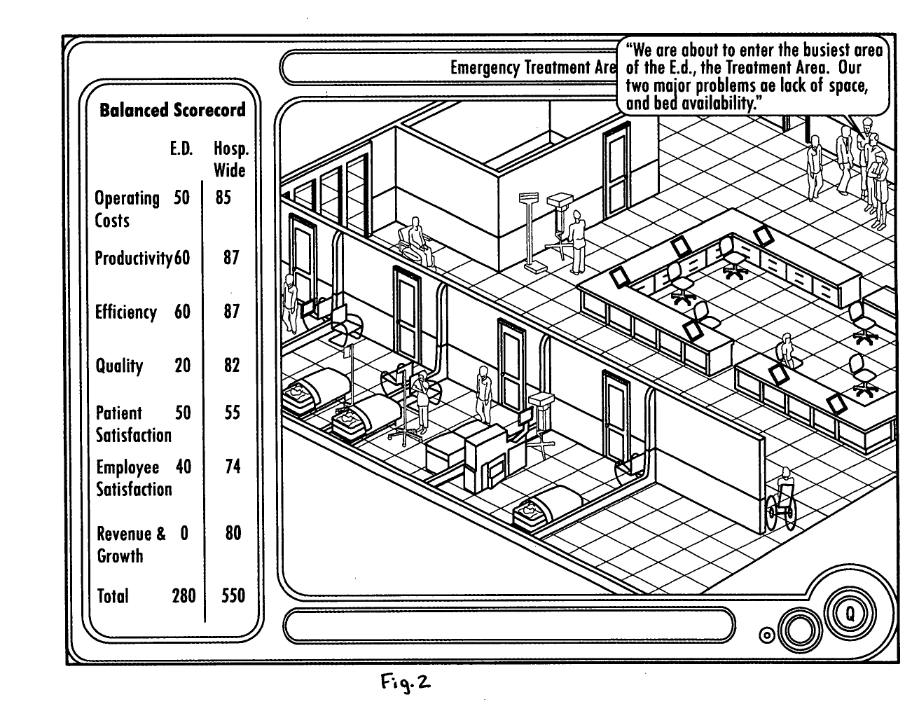

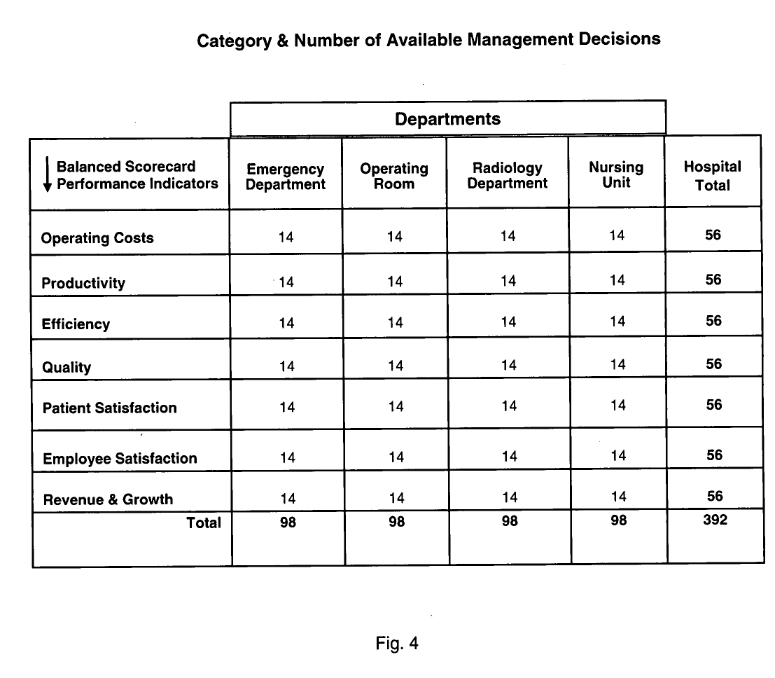

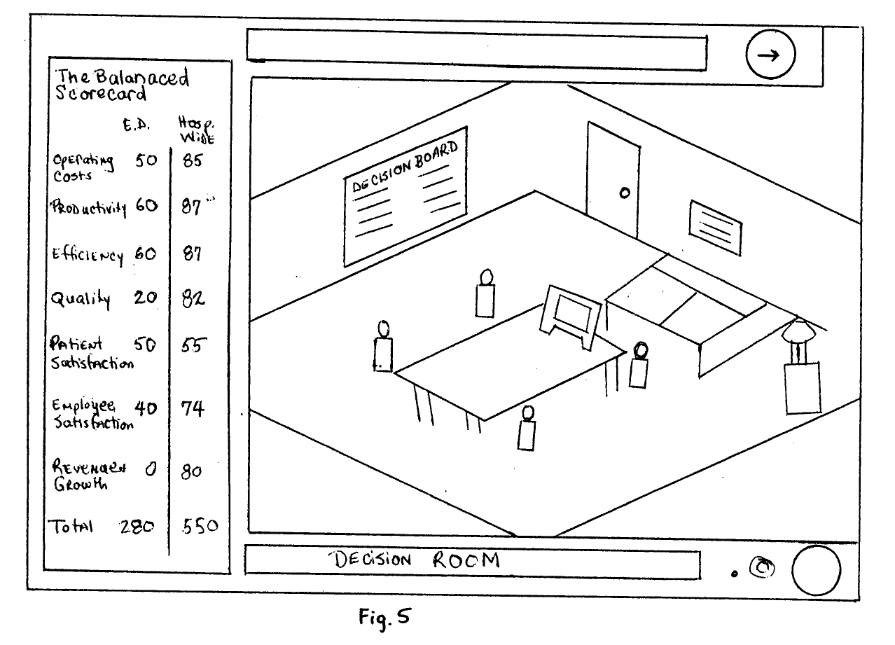

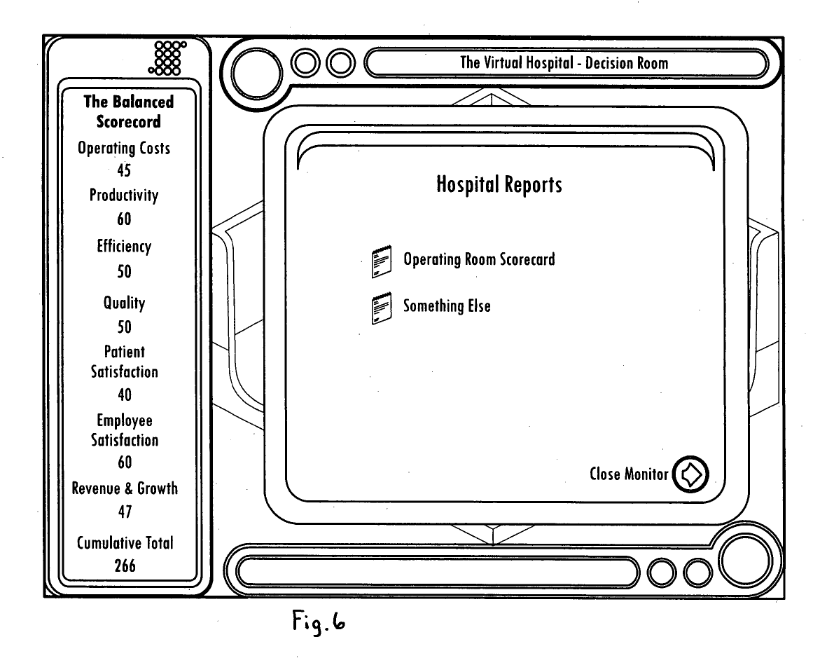

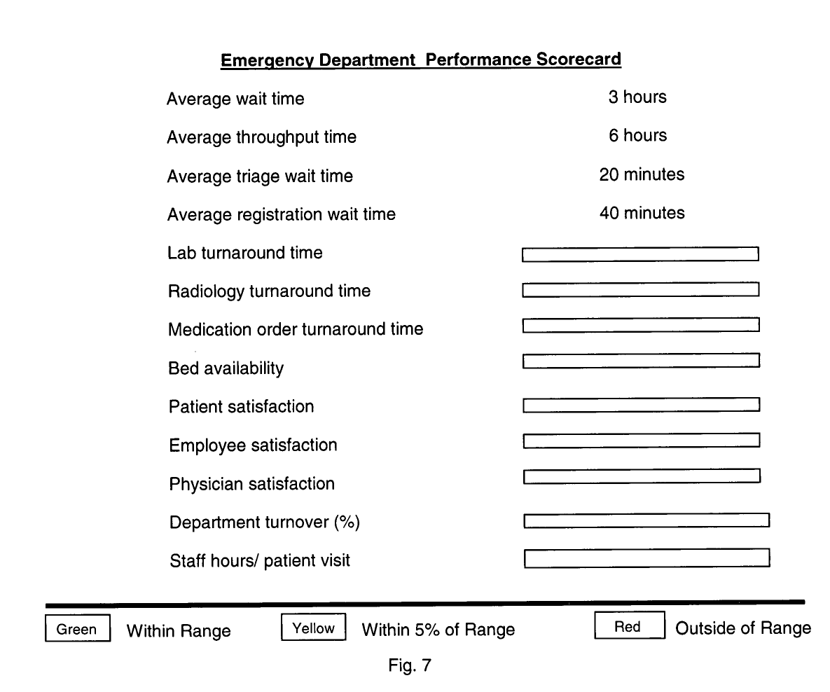

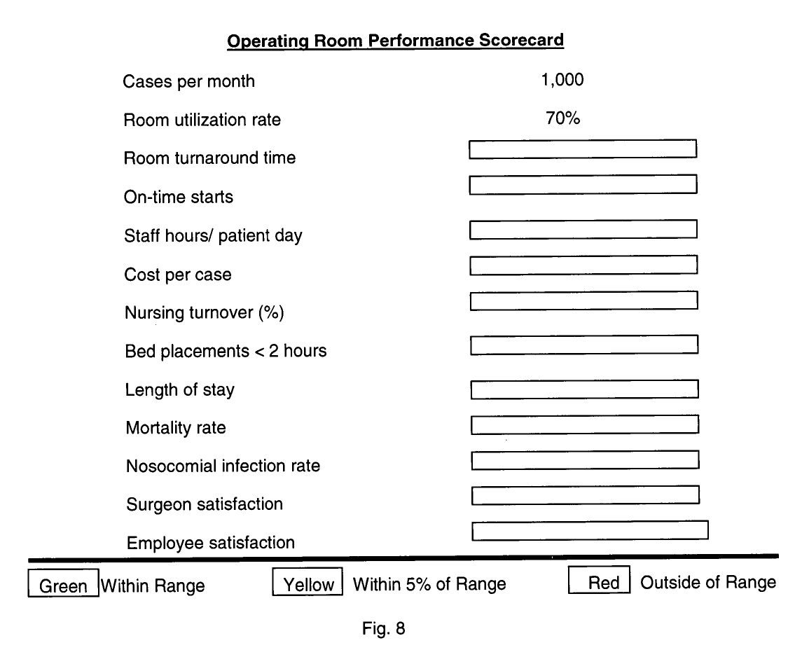

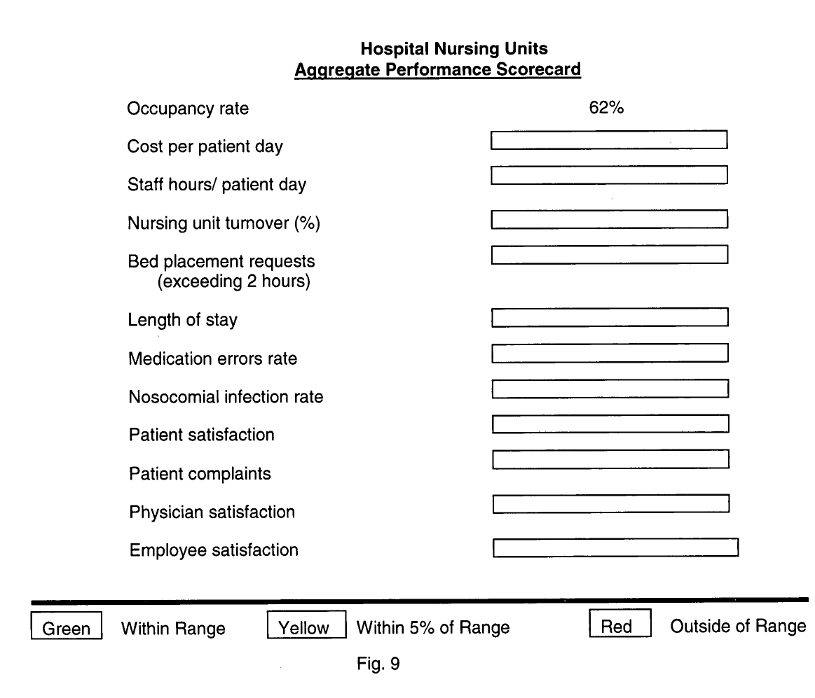

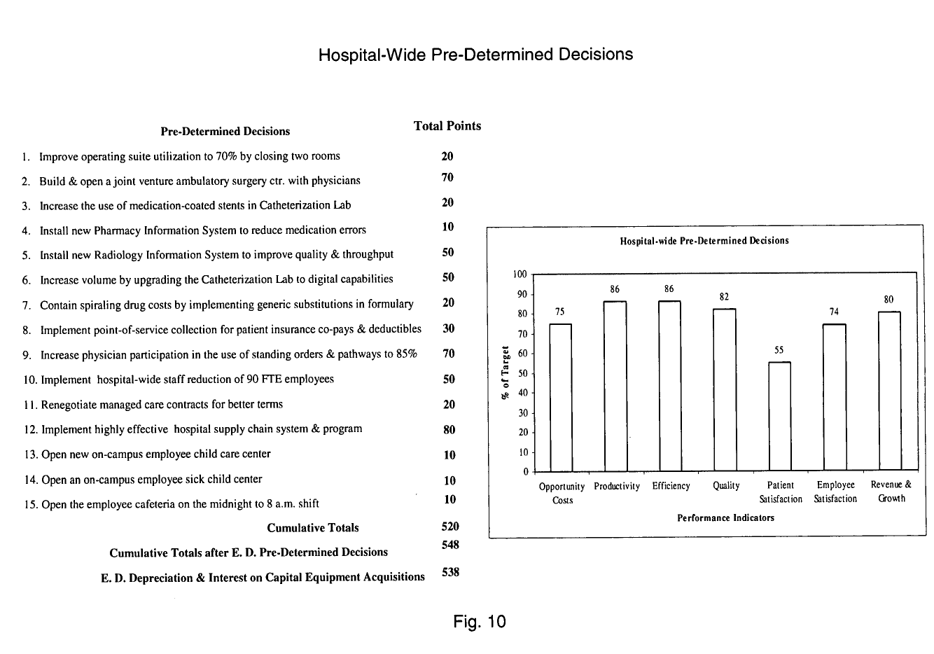

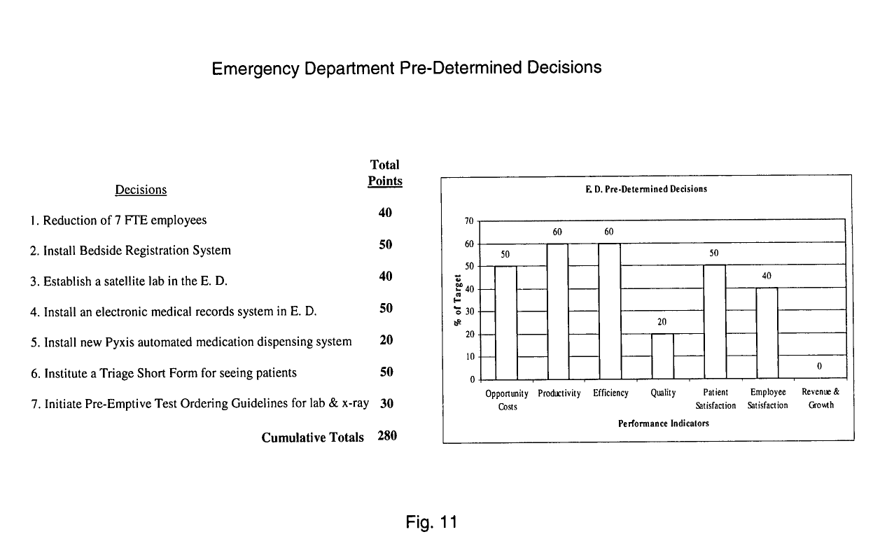

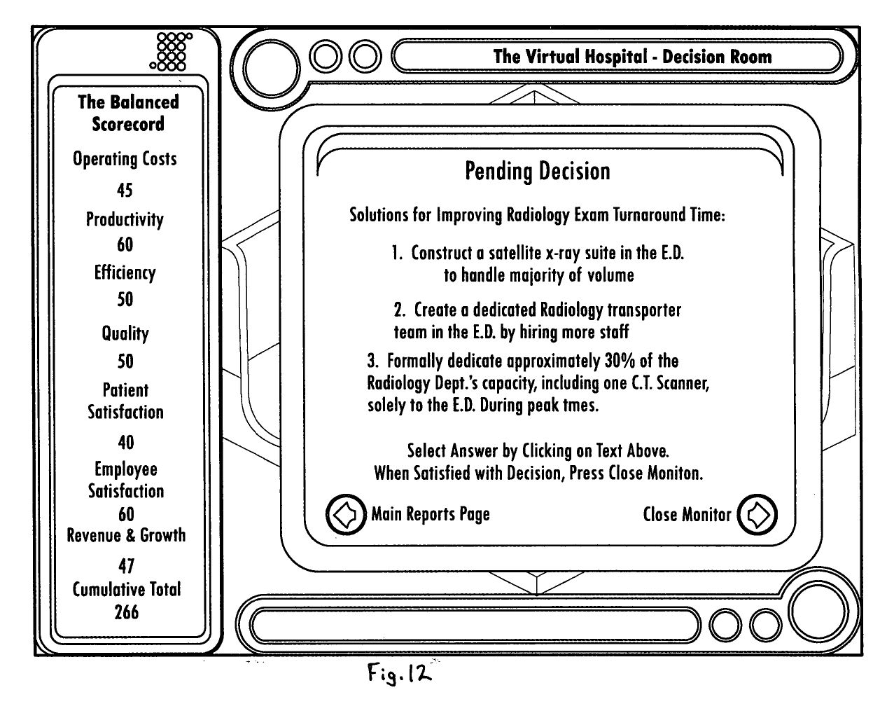

The Virtual Hospital Simulation includes three (3) major components in the assembly process. Those three components are:
1) The construction of “computerized graphics display system” on the computer screen using Macromedia Flash and complimentary computer applications [as seen in FIGS. 1-3], and
2) The construction of a “database management system” using Access and/or Sequel computer applications to house the query, manipulation, and storage of the data and decisions [as seen in FIGS. 4, 7-11, and 13-2-], and
3) Using computer coding and programming language to connect the graphics display system (#1 above), and the database management system (#2 above) together. The users will be able to interact, manipulate, and query the database, as well as switch back and forth between departments and reports by clicking on the icons positioned in the graphics display window on the computer screen as they progress through the simulation. As found in FIGS. 1-3, 5, 6, and 12]

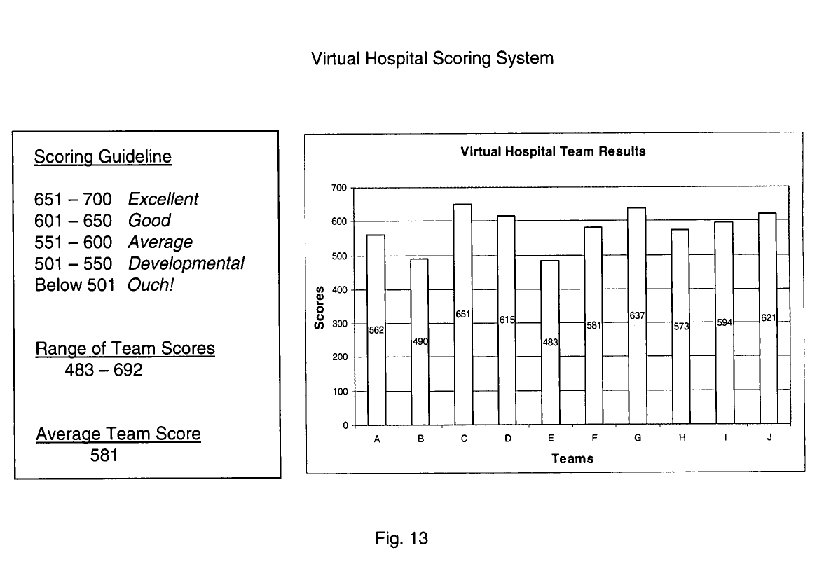

The following table is the hospital simulation “Scoring Guidelines” to be used by participants (also seen in FIG. 13):

| Hospital | | Each Department |
|---|---|---|
| 651-700 | Excellent | 176-200 |
| 601-650 | Good | 151-175 |
| 551-600 | Average | 126-150 |
| 501-550 | Developmental | 101-125 |
| Below 501 | Ouch!! | Below 101 |

There are four [4] departments.

### TIME REQUIRED TO COMPLETE THE SIMULATION

The tour and decision-making process takes about four (4) hours to complete; one hour in each module. Within each module, approximately 15 minutes will be dedicated to the physical walk-through (including encounters with departmental staff), and the remaining 45 minutes will be in the Decision Room, deliberating decisions. Each module will have approximately 100 possible decision selections organized in fashion similar to an organization's balanced scorecard structure. If the participants wish to extend the length of time in the simulation, the program can easily accommodate this.

### CUSTOMIZATION CAPABILITIES OF THE SIMUALTION

Some aspects of the simulation will have windows to allow for specific client customization needs. The areas of customization will include:

A. Hospital External Environmental Influences (for Example):
Prospective payment reimbursement
Rising uncompensated care
Spiraling labor costs
Ubiquitous malpractice liability climate
Specialty physician coverage of the E. D.
Availability of workforce/Staffing recruitment & retention
Contentious managed care contracting
Increasing competition in the local market
Narrowing access to capital

B. Hospital Background Information (for Example):

| Name: | The Well-Managed Virtual Hospital |
|---|---|
| Ownership Status: | Private, not-for-profit |
| Licensed Beds: | 550 |
| Avg. Daily Census: | 362 |
| Occupancy Level: | 62% |
| Annual Admissions: | 24,000 |
| Patient Days (adjusted): | 132,000 |
| Avg. LOS: | 5.5 |
| FTEs: | 2,172 |
| Case Mix Index: | 1.2 |

C. Organizational Financial Parameters (for Example):
Annual Operating Budget: $200 million
Operating Margin (most recent period): $5 million loss
Operating Margin (proposed period): $7 million gain
Operating Margin (gap): $12 million

D. Hospital-Wide Challenges (with the following examples):
Financial Turnaround
Competing hospitals with good reputations
Admissions have declined by 2% from prior period
Employee productivity overall is below the 50th percentile
The ALOS is at 5.5 days, which is 10% above peer institutions

E. Emergency Department Background Information (for Example):

| | |
|---|---|
| Designation: | Level Trauma Center |
| Annual Visits: | 60,000 |
| Treatment Rooms: | 23 |
| Paid FTEs: | 151 |
| Operating Budget: | $10.4 million |

Emergency Department Challenges:
   A major competitor has just expanded its E. D. services including offering a guarantee of being seen by a physician within 30 minutes of arrival.
   The department is approximately 10% above peer institutions recently benchmarked against.
   The department is experiencing less than optimal patient throughput and support service turnaround time.

F. Emergency Department Operational Information (for Example):

Wait Time:

| | |
|---|---|
| Number of patients seen in last 24 hours: | 164 |
| % patients leaving without being seen (walk-out rate): | 5% |
| Number of patients currently waiting to be seen: | 40 |
| Average wait time | 3 hours |

E. D. Problems:
   Overcrowding
   Excessive wait time
   Poor test turnaround time (TAT)
   Excessive length of stay
   Patient dissatisfaction
Contributing Factor:
   Availability of space
   Productivity
   Non-optimal efficiency
   Communications breakdowns
   Bed availability
   Staffing & scheduling

G. Hospital-Wide Gap Analysis/Performance Improvement Target:

| PERFORMANCE INDICATORS | GAP (Increase/decrease Needed) |
|---|---|
| Operating Costs | $9 million (decrease) |
| Productivity | 181 FTEs (decrease) |
| | (0.5 FTE/AOB) (decrease) |
| Efficiency | 0.5 Day LOS (decrease) |
| | 3 Hours/Pt. Thru-put (decrease) |
| Quality | 100 points (increase) |
| Patient Satisfaction | 8 points (increase) |
| Employee Satisfaction | 5 points (increase) |
| Revenue & Growth | $3 million (increase) |

H. Emergency Department Gap Analysis/Performance Improvement Target:

| PERFORMANCE INDICATORS | GAP (Increase/Decrease Needed) |
|---|---|
| Operating Costs | $750,000 (decrease) |
| Productivity | 14 FTEs (decrease) |
| | (0.5 FTE/Visit) (decrease) |
| Efficiency | 3 Hours/Pt. Thru-put (decrease) |
| Quality | 100 points (increase) |
| Patient Satisfaction | 7 points (increase) |
| Employee Satisfaction | 9 points (increase) |
| Revenue & Growth | 5% in Total Visits (increase) |

### THE “DECSISION ROOM” IN THE HOSPITAL SIMULATION

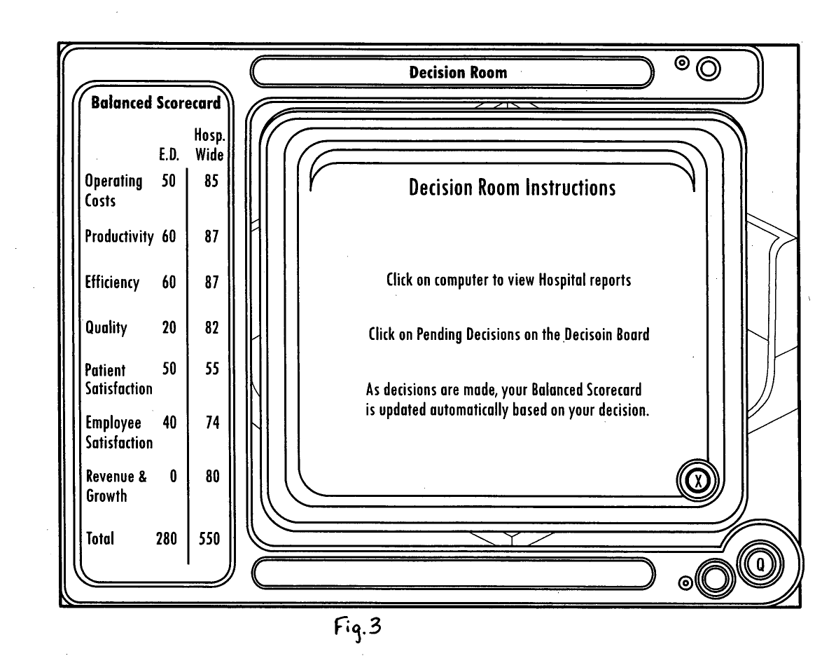

The Decision Room is the central control point and decision-making venue of the simulation. Each time the participants complete touring a particular department, they return to the Decision Room. The Decision Room has the appearance of a large conference that has been stocked with information and reports strategically located around the room to assist them with their decision-making process. A navigation panel, containing icons, is provided to assist participants in easily moving around the Decision Room and back and fourth to each department toured in the simulation. Instructions on how operate within the Decision Room are provided in the Room. FIG. 3 is an example of Room instructions.

We claim:

1. The Well-Managed Virtual Hospital, web-based and compact disc-based, 3-D interactive business motion simulation of running a real hospital.

2. The computer-based, audiovisual simulation is intended to be a training, educational, and entertainment tool focusing on the quality and effectiveness of the management decision-making process.

3. The business simulation contains graphic audiovisual user interfaces, including icons, modeled after a real hospital setting.

4. The business simulation contains a graphic display and depiction of a hospital emergency department, operating room, radiology department, nursing unit, conference room/decision-making room, and other departments.

5. The business simulation contains continuously present and visible balanced scorecards measuring a team's decision-making effectiveness at the departmental and hospital-wide level, simultaneously.

6. The business simulation provides “real-time” scoring and assessment of performance throughout the simulation from beginning to end.

7. The primary goals of The Well-Managed Virtual Hospital simulation are knowledge transfer, sharpened management skills, and improve individual and team performance.

8. A “virtual” management team tours the hospital and gathers information in the business simulation. The decisions made in relationship to the gathered information are then assessed for effectiveness.

9. The use of the “Decision Room” is a very important part of the business simulation.

10. A proprietary scoring system incorporated into the balanced scorecard system has been developed to function as a key part of the database management system.

11. Certain aspects of the business simulation, including hospital background and characteristics, can be customized to specific clients.

12. A bar charting system is an integral part of the performance reporting.
